(19) United States
(12) Patent Application Publication
(10) Pub. No.: US 2020/0005420 A1
(43) Pub. Date: Jan. 2, 2020

(54) SYSTEMS AND METHODS FOR TRANSPORTATION CAPACITY DISPATCH

(71) Applicant: BEIJING DIDI INFINITY TECHNOLOGY AND DEVELOPMENT CO., LTD., Beijing (CN)

(72) Inventors: Gongzheng WANG, Beijing (CN); Niping ZHANG, Beijing (CN); Lu LI, Beijing (CN)

(73) Assignee: BEIJING DIDI INFINITY TECHNOLOGY AND DEVELOPMENT CO., LTD., Beijing (CN)

(21) Appl. No.: 16/565,584

(22) Filed: Sep. 10, 2019

Related U.S. Application Data
(63) Continuation of application No. PCT/CN2017/104585, filed on Sep. 29, 2017.

(30) Foreign Application Priority Data
Jun. 21, 2017 (CN) 201710476717.7

(51) Int. Cl. G06Q 50/30; G06Q 10/02

(52) U.S. Cl. CPC G06Q 50/30; G06Q 10/02

(57) ABSTRACT

A system includes a storage device storing a set of instructions and at least one processor in communication with the storage device. When executing the instructions, the at least one processor is configured to cause the system to obtain a dispatch demand associated with a target service area and determine at least one first candidate service provider for the dispatch demand. The at least one processor may also cause the system to transmit a dispatch request to the at least one first candidate service provider. The at least one processor may further cause the system to determine, among the at least one first candidate service provider, a second candidate service provider, and transmit a service order associated with the target service area to the second candidate service provider at a first time point.

### CROSS-REFERENCE TO RELATED APPLICATION

This application is a continuation of International Application No. PCT/CN2017/104585, filed on Sep. 29, 2017, which claims priority of Chinese Patent Application No. 201710476717.7, filed on Jun. 21, 2017. The disclosure of the above-referenced application is expressly incorporated herein by reference in its entirety.

### TECHNICAL FIELD

The present disclosure generally relates to online O2O services and platforms, and in particular, to systems and methods for transportation capacity dispatch for online O2O services and platforms.

### BACKGROUND

With the development of Internet technology, O2O services, such as online taxi-hailing services and delivery services, play a significant role in people's daily life. For example, online taxi-hailing has been heavily used by ordinary persons (e.g., a passenger). Through an online O2O service platform, the user may request an O2O service in the form of an O2O service through an application installed in a user equipment, such as a smartphone terminal.

### SUMMARY

According to an aspect of the present disclosure, a system may include at least one non-transitory computer-readable storage medium storing a set of instructions and at least one processor in communication with the at least one non-transitory computer-readable storage medium. When executing the set of instructions, the at least one processor may cause the system to obtain a dispatch demand associated with a target service area and determine at least one first candidate service provider for the dispatch demand. The at least one processor may also cause the system to transmit a dispatch request to the at least one first candidate service provider. The at least one processor may further cause the system to determine, among the at least one first candidate service provider, a second candidate service provider, and transmit a service order associated with the target service area to the second candidate service provider at a first time point.

In some embodiments, the dispatch request may include an inquiry to ask the at least one first candidate service provider whether to accept to go to the target service area. The at least one processor may further cause the system to determine, among the at least one first candidate service provider, the second candidate service provider who accepts the dispatch request.

In some embodiments, the first time point may be a time point when the second candidate service provider arrives in the target service area.

In some embodiments, the at least one processor may also cause the system to obtain first information of a transportation capacity of at least one service area, and determine, among the at least one service area, the target service area based on the first information of the transportation capacity of the at least one service area.

In some embodiments, the at least one processor may also cause the system to determine at least one candidate service area associated with the target service area, and determine the at least one first candidate service provider in the at least one candidate service area.

In some embodiments, the at least one processor may also cause the system to obtain second information of a transportation capacity of at least one service area near the target service area, and determine the at least one candidate service area among the at least one service area near the target service area based on the second information of the transportation capacity of the at least one service area near the target service area.

In some embodiments, the at least one processor may also cause the system to determine a first service time period of the second candidate service provider based on a first pre-determined service duration and the time point when the second candidate service provider accepts the dispatch request. The at least one processor may further cause the system to determine the first time point within the first service time period of the second candidate service provider, and transmit the service order associated with the target service area to the second candidate service provider at the determined first time point.

In some embodiments, the at least one processor may also cause the system to determine a second service time period of the second candidate service provider based on a second pre-determined service duration and the time point when the second candidate service provider arrives in the target service area. The at least one processor may further cause the system to determine the first time point within the second service time period of the second candidate service provider, and transmit the service order associated with the target service area to the second candidate service provider at the determined first time point.

In some embodiments, the at least one processor may also cause the system to obtain the number of candidate service providers who accept the dispatch request among the at least one first candidate service provide, and determine whether the obtained number of the candidate service providers who accept the dispatch request exceeds a threshold. Upon a determination that the obtained number of the candidate service providers who accept the dispatch request exceeds the threshold, the at least one processor may further cause the system to stop transmitting the dispatch request to the at least one first candidate service provider.

In some embodiments, the dispatch demand may further include a demand time related to a dispatch condition. The at least one processor may also cause the system to determine the at least one first candidate service provider at a second time point associated with the demand time related to the dispatch condition.

In some embodiments, the dispatch condition may be at least one of a weather, a time interval of a day, a region, a date, or an event.

In some embodiments, the dispatch demand may further include a target number of service providers. The at least one processor may also cause the system to obtain the number of candidate service providers who accept the dispatch request among the at least one first candidate service provider, and determine whether the obtained number is less than the target number of service providers. Upon a determination that the obtained number is less than the target number of service providers, the at least one processor may further cause the system to obtain at least one third candidate service provider for the dispatch demand.

According to another aspect of the present disclosure, a computer-implemented method may include one or more of the following operations performed by at least one processor. The method may include obtaining a dispatch demand associated with a target service area and determining at least one first candidate service provider for the dispatch demand. The method may also include transmitting a dispatch request to the at least one first candidate service provider. The method may further include determine, among the at least one first candidate service provider, a second candidate service provider, and transmitting a service order associated with the target service area to the second candidate service provider at a first time point.

According to yet another aspect of the present disclosure, a system implemented on a computing device may have a processor, a storage medium, and a communication platform connected to a network. The system may include a dispatch module configured to obtain a dispatch demand associated with a target service area and determine at least one first candidate service provider for the dispatch demand. The system may also include a dispatch request transmission module configured to transmit a dispatch request to the at least one first candidate service provider. The dispatch module may further be configured to determine, among the at least one first candidate service provider, a second candidate service provider. The system may further include a service order transmission module configured to transmit a service order associated with the target service area to the second candidate service provider at a first time point.

According to yet another aspect of the present disclosure, a non-transitory machine-readable storage medium storing instructions that, when executed by at least one processor of a system, cause the system to perform a method. The method may include obtaining a dispatch demand associated with a target service area and determining at least one first candidate service provider for the dispatch demand. The method may also include transmitting a dispatch request to the at least one first candidate service provider. The method may further include determine, among the at least one first candidate service provider, a second candidate service provider, and transmitting a service order associated with the target service area to the second candidate service provider at a first time point.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary O2O service system according to some embodiments of the present disclosure;

FIG. 2 is a block diagram illustrating an exemplary processing engine according to some embodiments of the present disclosure;

FIG. 3 is a schematic diagram illustrating exemplary hardware and/or software components of an exemplary mobile device on which a user terminal may be implemented according to some embodiments of the present disclosure;

FIG. 4A is a block diagram illustrating an exemplary processing device according to some embodiments of the present disclosure;

FIG. 4B is a block diagram illustrating an exemplary service area determination module according to some embodiments of the present disclosure;

FIG. 4C is a block diagram illustrating an exemplary service order transmission module according to some embodiments of the present disclosure;

FIG. 5 is a flowchart illustrating an exemplary process for dispatching transportation service resource according to some embodiments of the present disclosure;

FIG. 6 is a flowchart illustrating an exemplary process for dispatching transportation service resource according to some embodiments of the present disclosure;

FIG. 7 is a flowchart illustrating an exemplary process for dispatching transportation service resource according to some embodiments of the present disclosure; and

FIG. 8 is a flowchart illustrating an exemplary process for dispatching transportation service resource according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, steps, elements, and/or components, but do not preclude the presence or addition of one or more other features, integers, steps, steps, elements, components, and/or groups thereof.

These and other features, and characteristics of the present disclosure, as well as the methods of step and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate steps that systems implement according to some embodiments described in the present disclosure. It is to be expressly understood, the steps of the flowchart may be implemented not in order. Conversely, the steps may be implemented in inverted order, or simultaneously. Moreover, one or more other steps may be added to the flowcharts. One or more steps may be removed from the flowcharts.

Moreover, while the system and method in the present disclosure are described primarily with regard to distributing a request for a transportation service, it should also be understood that the present disclosure is not intended to be limiting. The system or method of the present disclosure may be applied to any other kind of on-demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for transmitting and/or receiving an express. The application of the system or method of the present disclosure may be implemented on a user device and include a web page, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requestor, a customer, a driver, a provider, a service provider, or the like, or any combination thereof. The service request may be accepted by any one of a passenger, a service requestor, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requestor terminal” and “passenger terminal” in the present disclosure are used interchangeably to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to transportation capacity dispatch in an O2O service system. A dispatch demand associated with a target service area may be obtained. The dispatch demand may be triggered when the target service area has an insufficient transportation capacity, or the target service area satisfies a dispatch condition. For example, the dispatch demand may be triggered when the target service area does not have enough candidate service providers to provide services. As another example, the dispatch demand may be triggered when the target service area has a terrible weather that may cause a traffic jam.

One or more first candidate service providers for the dispatch demand may be determined. The first candidate service providers may be candidate service providers in one or more other service areas waiting for a service order. A dispatch request may be transmitted to one or more of the first candidate service providers to inquire whether to accept to go to the target service area. Upon a determination that a second candidate service provider among the first candidate service providers who accept the dispatch request (i.e., indicating an agreement to go to the target service area), a service order associated with the target service area may be transmitted to the second candidate service provider. As such, candidate service providers in one or more other service areas may be dispatched to the target service area to provide service. It may improve the service efficiency of the O2O service system.

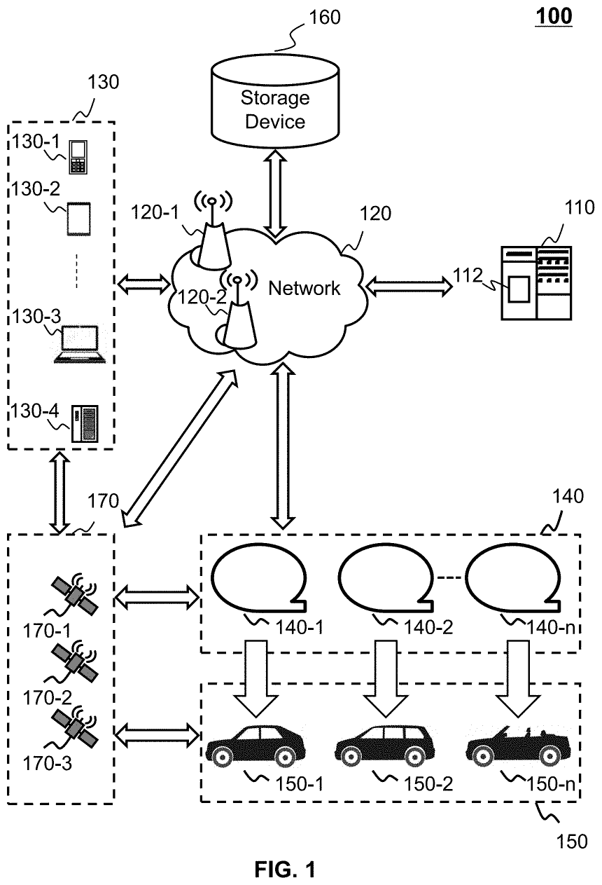

FIG. 1 is a block diagram illustrating an exemplary O2O service system 100 according to some embodiments. For example, the O2O service system 100 may be an online transportation service platform for transportation services. The O2O service system 100 may include a server 110, a network 120, a service requestor terminal 130, a service provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any online service, such as booking a meal, shopping, or the like, or any combination thereof.

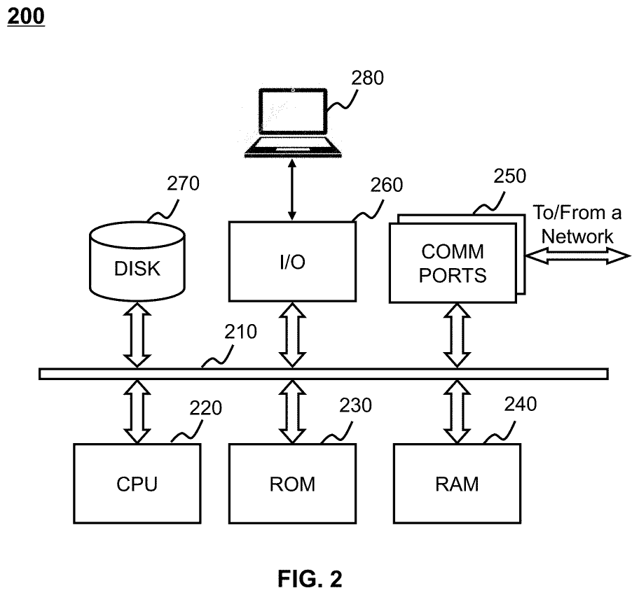

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requestor terminal 130, the service provider terminal 140, and/or the storage device 160 via the network 120. As another example, the server 110 may be directly connected to the service requestor terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine one or more candidate service provider terminals in response to the service request received from the service requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the service requestor terminal 130, the service provider terminal 140, the vehicle 150, the storage device 160, and the navigation system 170) may transmit information and/or data to other component(s) of the O2O service system 100 via the network 120. For example, the server 110 may receive a service request from the service requestor terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the O2O service system 100 may be connected to the network 120 to exchange data and/or information.

In some embodiments, a passenger may be an owner of the service requestor terminal 130. In some embodiments, the owner of the service requestor terminal 130 may be someone other than the passenger. For example, an owner A of the service requestor terminal 130 may use the service requestor terminal 130 to transmit a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the service requestor terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requestor terminal 130 may be a device with positioning technology for locating the position of the passenger and/or the service requestor terminal 130.

The service provider terminal 140 may include a plurality of service provider terminals 140-1, 140-2, . . . , 140-n. In some embodiments, the service provider terminal 140 may be similar to, or the same device as the service requestor terminal 130. In some embodiments, the service provider terminal 140 may be customized to be able to implement the online on-demand transportation service. In some embodiments, the service provider terminal 140 may be a device with positioning technology for locating the service provider, the service provider terminal 140, and/or a vehicle 150 associated with the service provider terminal 140. In some embodiments, the service requestor terminal 130 and/or the service provider terminal 140 may communicate with another positioning device to determine the position of the passenger, the service requestor terminal 130, the service provider, and/or the service provider terminal 140. In some embodiments, the service requestor terminal 130 and/or the service provider terminal 140 may periodically transmit the positioning information to the server 110. In some embodiments, the service provider terminal 140 may also periodically transmit the availability status to the server 110. The availability status may indicate whether a vehicle 150 associated with the service provider terminal 140 is available to carry a passenger. For example, the service requestor terminal 130 and/or the service provider terminal 140 may transmit the positioning information and the availability status to the server 110 every thirty minutes. As another example, the service requestor terminal 130 and/or the service provider terminal 140 may transmit the positioning information and the availability status to the server 110 each time the user logs into the mobile application associated with the online on-demand transportation service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the service requestor terminal 130 and/or the service provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the service requestor terminal 130, or the service provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the service requestor terminal 130, the service provider terminal 140). In some embodiments, the storage device 160 may be part of the server 110.

The navigation system 170 may determine information associated with an object, for example, one or more of the service requestor terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the service requestor terminal 130, the service provider terminal 140, or the vehicle 150 via wireless connections.

In some embodiments, one or more components of the O2O service system 100 (e.g., the server 110, the service requestor terminal 130, the service provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the O2O service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smartwatch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the O2O service system 100 performs, the element may perform through electrical signals and/or electromagnetic signals. For example, when a service requestor terminal 130 transmits out a service request to the server 110, a processor of the service requestor terminal 130 may generate an electrical signal encoding the request. The processor of the service requestor terminal 130 may then transmit the electrical signal to an output port. If the service requestor terminal 130 communicates with the server 110 via a wired network, the output port may be physically connected to a cable, which further may transmit the electrical signal to an input port of the server 110. If the service requestor terminal 130 communicates with the server 110 via a wireless network, the output port of the service requestor terminal 130 may be one or more antennas, which convert the electrical signal to electromagnetic signal. Similarly, a service provider terminal 130 may receive an instruction and/or service request from the server 110 via electrical signal or electromagnet signals. Within an electronic device, such as the service requestor terminal 130, the service provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service requestor terminal 130, and/or the service provider terminal 140 may be implemented according to some embodiments of the present disclosure. For example, the processing engine 112 may be implemented on the computing device 200 (e.g., CPU 220) and configured to perform functions of the processing engine 112 disclosed in this disclosure.

The computing device 200 may be a general-purpose computer or a special purpose computer; both may be used to implement an O2O system for the present disclosure. The computing device 200 may be used to implement any component of the O2O service as described herein. For example, the processing engine 112 may be implemented on the computing device 200 (e.g., CPU 220), via its hardware, software program, firmware, or any combination thereof. Although only one such computer is shown, for convenience, the computer functions relating to the O2O service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read-only memory (ROM) 230, or a random access memory (RAM) 240, for various data files to be processed and/or transmitted by the computer. The exemplary computer platform may also include program instructions stored in the ROM 230, RAM 240, and/or another type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be noted that the computing device 200 in the present disclosure may also include multiple CPUs and/or processors. Thus steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

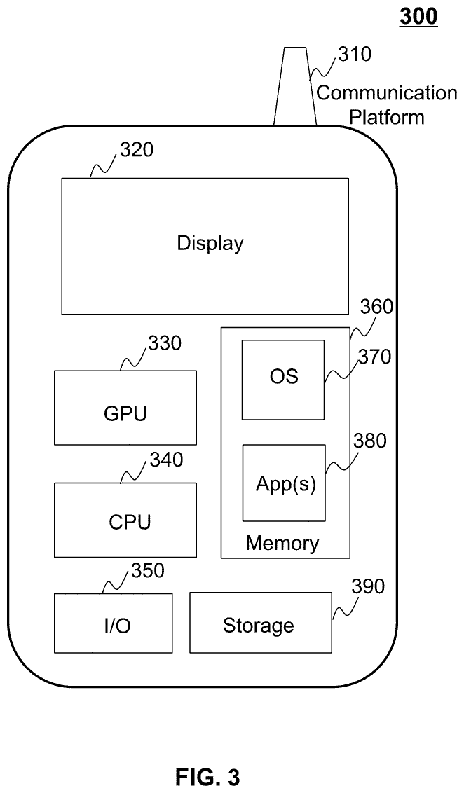

FIG. 3 is a schematic diagram illustrating exemplary hardware and/or software components of an exemplary mobile device 300 on which a user terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™ Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the O2O service system 100 via the network 120.

Computer hardware platforms that implement various modules, units, and their functionalities described in the present disclosure may be used as the hardware platform(s) for one or more of the elements described herein. A computer with user interface elements may be used to implement a personal computer (PC) or any other type of work station or terminal device. A computer may also act as a server if appropriately programmed.

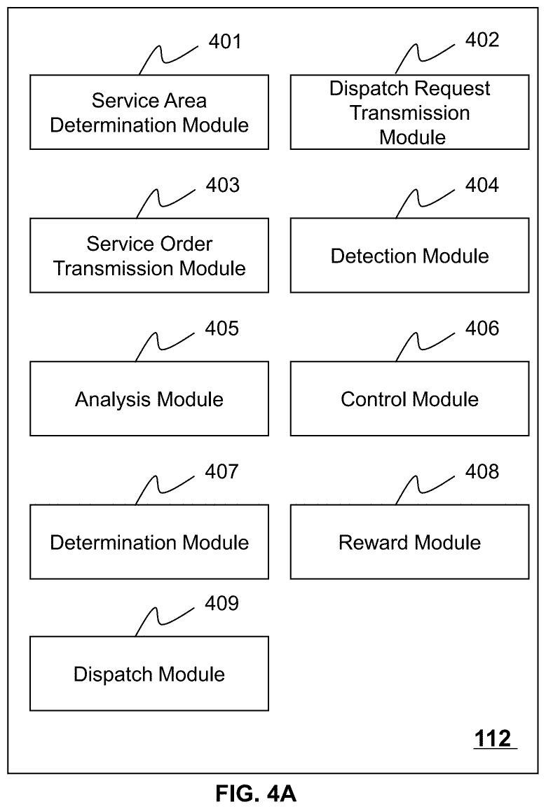

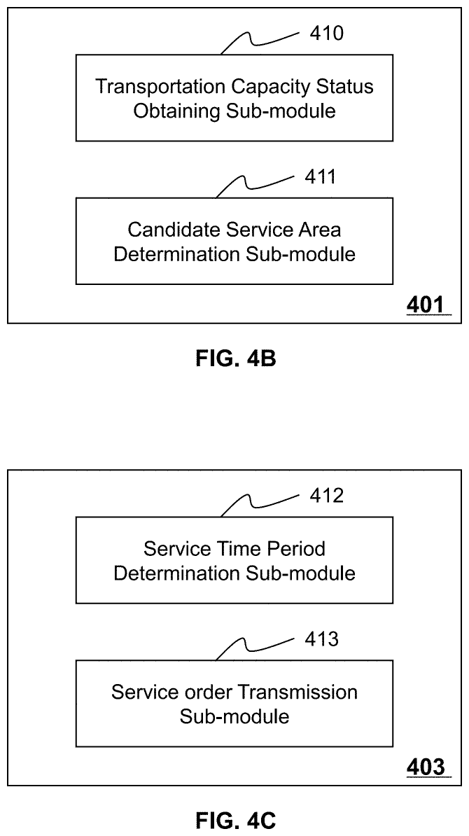

FIG. 4A is a block diagram illustrating an exemplary processing engine 112 according to some embodiments of the present disclosure. The processing engine 112 may include a service area determination module 401, a dispatch request transmission module 402, a service order transmission module 403, a detection module 404, an analysis module 405, a control module 406, a determination module 407, a reward module 408, and a dispatch module 409.

The service area determination module 401 may divide an area in a map into a plurality of service areas. As used herein, a service area may be an area having one or more service providers. The service area determination module 401 may divide the area randomly or according to an area-division rule. Additionally or alternatively, the service area determination module 401 may determine one or more candidate service areas associated with a target service area. The target service area may refer to a service area that needs more service providers dispatched from one or more other service areas currently or during a future period of time. The candidate service areas may refer to a service area that can provide service providers to the target service area. The candidate service areas may include a service area near the target service area, a service area having a surplus transportation capacity, a transportation capacity having a plenty number of candidate service providers (e.g., the number of candidate service providers being greater than a threshold), or the like, or any combination thereof.

In some embodiments, the service area determination module 401 may include a transportation capacity status obtaining sub-module 410 and a candidate service area determination sub-module 411. More descriptions regarding the transportation capacity status obtaining sub-module 410 and the candidate service area determination sub-module 411 may be found elsewhere in the present disclosure (e.g., FIG. 4B and the relevant descriptions).

The dispatch request transmission module 402 may transmit a dispatch request to one or more first candidate service providers. The dispatch request may refer to a request to inquire the first candidate service providers whether to accept to go to a target service area. As used herein, a candidate service provider may refer to a user who is waiting for a service order. The dispatch request transmission module 402 may transmit the dispatch request to different first candidate service providers at the same time or different time. In some embodiments, the dispatch request transmission module 402 may transmit the dispatch request to the provider terminals (e.g., the service provider terminal 140-1) associated with the first candidate service providers. The dispatch request may be transmitted to the provider terminals in any form, such as a text dispatch request, a video dispatch request, an audio dispatch request, or a graph dispatch request.

The service order transmission module 403 may transmit a service order associated with a target service area to a second candidate service provider at a time point. The second candidate service provider may be a candidate service provider who accepts a dispatch request (i.e., agree to go to the target service area) among the first candidate service providers. The service order associated with the target service area may be a service order whose start location and/or end location are/is within the target service area.

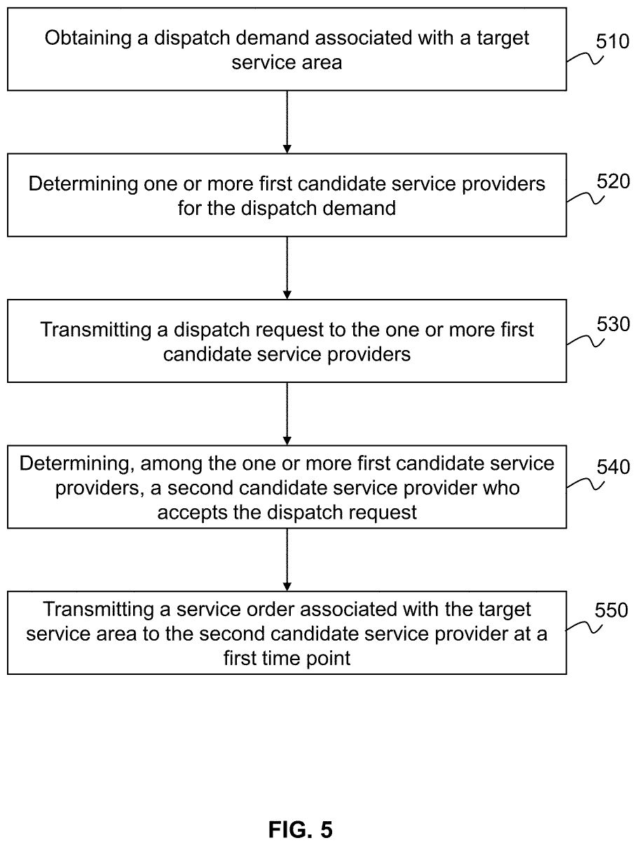

The time point may be anytime after the second candidate service provider accepts the dispatch request. For example, the time point may be a time point when (or immediately after) the second candidate service provider accepts the dispatch request. As another example, the time point may be determined by the service order transmission module 403 based on positioning information and/or a service time period of the second candidate service provider. In some embodiments, the service order transmission module 403 may apply different strategies for transmitting service orders according to different situations. More descriptions regarding the determination of the time point and/or the service order transmission strategies may be found elsewhere in the present disclosure (e.g., FIG. 5 and the relevant descriptions).

In some embodiments, the service order transmission module 403 may include a service time period determination sub-module 412 and a service order transmission sub-module 413. More descriptions regarding the service time period determination sub-module 412 and the service order transmission sub-module 413 may be found elsewhere in the present disclosure (e.g., FIG. 4C and the relevant descriptions).

The detection module 404 may determine whether a service area satisfies a dispatch condition. The dispatch condition may include an occurrence or a prediction of, such as a weather, a time interval of a day, a region, a date, or an event. For example, the detection module 404 may obtain information related to the service area from a storage device in the O2O service system 100 and/or from another system. The detection module 404 may also determine whether the service area satisfies the dispatch condition based on the information. Upon a determination that the service area satisfies the dispatch condition, the detection module 404 may designate the service area as a target service area. Additionally or alternatively, the detection module 404 may transmit a dispatch demand related to the service area to the dispatch module 409.

In some embodiments, upon a determination that the service area satisfies the dispatch condition, the detection module 404 may determine whether the service area has an insufficient transportation capacity. More descriptions regarding the transportation capacity of the service area may be found elsewhere in the present disclosure (e.g., FIG. 4B, step S10, and the relevant descriptions). Upon a determination that the service area has insufficient transportation capacity, the detection module 404 may designate the service area as a target service area. Additionally or alternatively, the detection module 404 may transmit a dispatch demand related to the service area to the dispatch module 409.

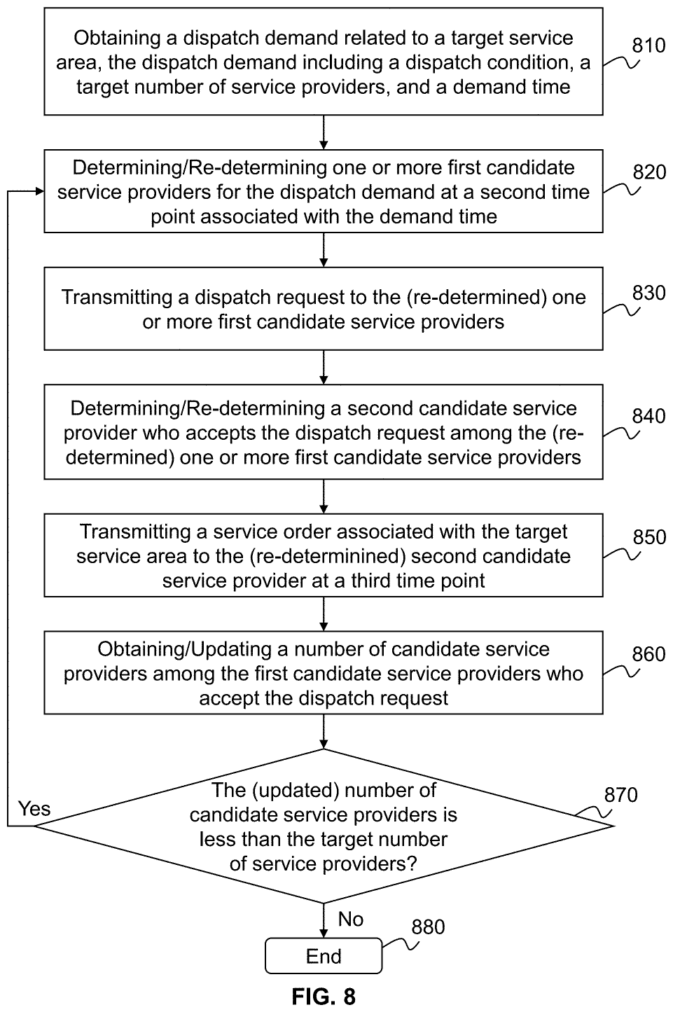

The analysis module 405 may obtain the number of the second candidate service providers who accept the dispatch request among the first candidate service providers. Additionally or alternatively, the analysis module 405 may compare the number of the second candidate service providers with a threshold. Upon a determination that the number is greater than the threshold, the analysis module 405 may transmit an instruction to the control module 406 to terminate transmitting dispatch request to the first candidate service providers. Additionally or alternatively, the analysis module 405 may determine a target number of service providers of a target service area. The target number of service providers may be a target number of service providers to be dispatched to the target service area from one or more other service areas. More descriptions regarding the determination of the target number of service providers may be found elsewhere in the present disclosure (e.g., FIG. 8 and the relevant descriptions).

The control module 406 may control the transmission of dispatch request to the first candidate service providers. For example, upon the analysis module 405 determines that the second candidate service providers who agree to go to the target service area being greater than the threshold, the control module 406 may stop the dispatch request from being transmitted to the first candidate service providers in the candidate service area.

The determination module 407 may determine whether the second candidate service provider who accepts the dispatch request arrives in the target service area within a time period. The time period may be any positive number, such as 5 minutes, 10 minutes. The time period may be a default parameter stored in a storage device (e.g., the storage device 160) or be set by a user (e.g., a user of the O2O service system 100) via a terminal. Upon a determination that the second candidate service provider arrive in the target service area within the time period, the determination 407 may transmit an instruction to the reward module 408 to issue a reward to the second candidate service provider.

The reward module 408 may issue a reward to a service provider. The reward may include a monetary reward, a performance score reward, or the like, or any combination thereof. For example, upon the determination module 407 determines that a second candidate service provider arrives in the target service area within the time period, the reward module 408 may issue a reward to the second candidate service provider.

The dispatch module 409 may obtain a dispatch demand associated with a target service area. The dispatch demand may be obtained from one or more components of the O2O service system 100, such as the storage device 160, the service area determination module 401, and/or the detection module 404. The dispatch module 409 may also determine one or more first candidate service providers for the dispatch demand. Additionally or alternatively, the dispatch module 409 may determine a second candidate service provider who accepts the dispatch request among the one or more first candidate service providers. In some embodiments, the dispatch module 409 may determine a demand time of the dispatch demand. The demand time may refer to a time when the dispatch demand needs to be satisfied. More descriptions regarding the determination of the first candidate service providers, the second candidate service provider, and/or the demand time may be found elsewhere in the present disclosure (e.g., FIGS. 5 and 8 and the relevant descriptions.

FIG. 4B is a block diagram illustrating an exemplary service area determination module according to some embodiments of the present disclosure. The service area determination module 401 may include a transportation capacity status obtaining sub-module 410 and a candidate service area determination sub-module 411.

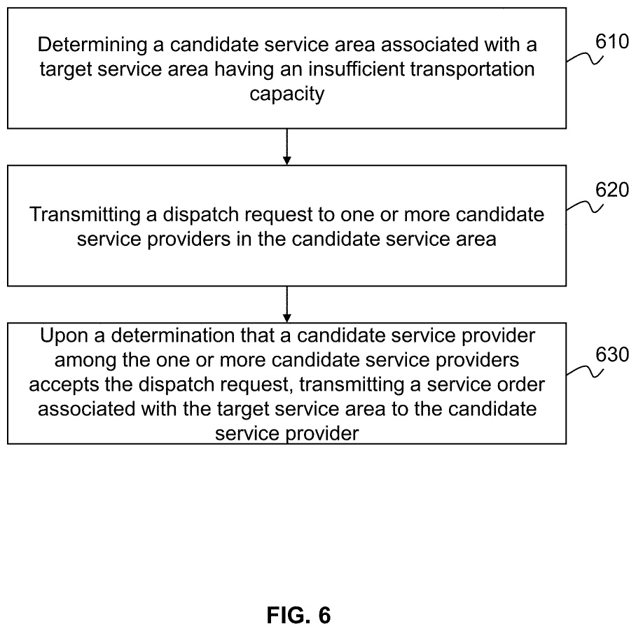

The transportation capacity status obtaining sub-module 410 may obtain and/or determine a transportation capacity of a service area. The transportation capacity of the service area may refer to supply and demand relationship between the number of service orders and the number of candidate service providers in the service area. The transportation capacity of the service area may include but is not limited a balanced transportation capacity, a surplus transportation capacity, or an insufficient transportation capacity. In some embodiments, the transportation capacity status obtaining sub-module 410 may obtain and/or determine the transportation capacity of one or more service areas near a target service area. More descriptions regarding the determination of the transportation capacity of the service area may be found elsewhere in the present disclosure (e.g., FIGS. 5 and 6 and the relevant descriptions).

The candidate service area determination sub-module 411 may determine a candidate service areas associated with a target service area. The candidate service areas may include a service area near the target service area, a service area having a surplus transportation capacity, a transportation capacity having a plenty number of candidate service providers (e.g., the number of candidate service providers being greater than a threshold), or the like, or any combination thereof. For example, the candidate service area determination sub-module 411 may determine a service area with a surplus transportation capacity among the service areas near the target service area as a candidate service area of the target service area.

FIG. 4C is a block diagram illustrating an exemplary order transmission module according to some embodiments of the present disclosure. The service order transmission module 403 may include a service time period determination sub-module 412 and a service order transmission sub-module 413

The service time period determination sub-module 412 may determine the service time period of a second candidate service provider who accepts the dispatch request (i.e., agree to go to target service area). The service time period may be any period of time after second candidate service provider accepts the dispatch request. In some embodiments, the service time period determination sub-module 412 may determine the service time period based on a first pre-determined service duration and a time point when the second candidate service provider accepts the dispatch request. Alternatively, the service time period determination sub-module 412 may determine the service time period based on a second pre-determined service duration and a time point when the second candidate service provider arrives in the target service area. More descriptions regarding the determination of the service time period of the second candidate service provider may be found elsewhere in the present disclosure (e.g., FIG. 5 and the relevant descriptions).

The service order transmission sub-module 413 may transmit a service order associated with the target service area to the second candidate service provider at any time point within the service time period of the second candidate service provider.

It should be noted that the above descriptions of FIGS. 4A to 4C are provided for the purposes of illustration, and not intended to limit the scope of the present disclosure. For persons having ordinary skills in the art, various modifications and changes in the forms and details of the application of the above method and system may occur without departing from the principles of the present disclosure. In some embodiments, the processing engine 112 may include one or more other modules. For example, the processing engine 112 may include a storage module to store data generated by the modules in the processing engine 112. In some embodiments, one or more modules of the processing engine 112 illustrated in FIGS. 4A to 4C may be omitted. In some embodiments, one module may perform the functions of two or more modules described above. For example, the dispatch request transmission module 402 and the service order transmission module 403 may form a module to transmit dispatch request and/or service order to service providers. However, those variations and modifications also fall within the scope of the present disclosure.

FIG. 5 is a flowchart illustrating an exemplary process for dispatching transportation service resource according to some embodiments of the present disclosure.

The process 500 may be executed by the O2O service system 100. For example, the process 500 may be implemented as a set of instructions (e.g., an application) stored in storage device 160. The processing engine 112 (which may be implemented on the CPU 220) may execute the set of instructions and may accordingly be directed to perform the process 500 in an online O2O service platform. The platform may be an Internet-based platform that connects O2O service providers and requestors through the Internet.

In 510, the processing engine 112 (e.g., the dispatch module 409) may obtain a dispatch demand associated with a target service area. The dispatch demand may be obtained from one or more components of the O2O service system 100, such as the storage device 160, the service area determination module 401, and/or the detection module 404. In some embodiments, the dispatch module 409 may obtain the dispatch demand in the form of one or more electrical signals that encode data of the dispatch demand.

In the O2O service system 100, the service area determination module 401 may divide an area in a map into a plurality of service areas. As used herein, a service area may be an area having one or more service providers. The service area determination module 401 may divide the area into the plurality of the service area randomly or according to an area-division rule. The area-division rule may include a size of the area, a density of population in the area, a division of administrative regions in the area, a density of office buildings in the area, the number of historical service orders in the area, or the like, or any combination thereof. For example, New York may be divided into a plurality of service areas with the same size. As another example, New York may be divided into a plurality of service areas, each of which may have similar density of office buildings or population.

The service providers may refer to users who can provide an O2O service, such as a taxi-hailing service, a food delivery service. The service providers in the target service area may have been in one of service statuses such as in the process of providing service, waiting for a service order, or out of service. A service provider who is waiting for a service order may be referred herein as a candidate service provider.

The target service area may refer to a service area that needs more service providers dispatched from one or more other service areas currently or during a future period of time. For example, in an online car-hailing service system, the target service area may be a service area that needs more drivers dispatched from one or more other service areas. As another example, in a take-out delivery system, the target service area may be a service area that needs more delivery staffs dispatched from one or more other service areas.

The dispatch demand associated with the target service area may be a demand for dispatching service providers to the target service area. The dispatch demand may be a real-time dispatch demand that needs to be satisfied immediately or substantially immediately. The real-time dispatch demand may indicate that the target service area may need service providers dispatched from one or more other service areas immediately or substantially immediately. Alternatively, the dispatch demand may be a non-real-time dispatch demand that needs to be satisfied at a time point after the dispatch demand is obtained. The non-real-time dispatch demand may indicate that the target service area may need service providers dispatched from one or more other service areas at the time point after the dispatch demand is obtained, such as 1 hour later or at 9:00 a.m. on Aug. 1, 2017. As used herein, a time when the dispatch demand needs to be satisfied may be referred herein as a demand time of the dispatch demand.

In some embodiments, the dispatch demand may be associated with a target service area with an insufficient transportation capacity. A transportation capacity status (also referred herein as a transportation capacity) of a service area may refer to supply and demand relationship between the number of service orders and the number of candidate service providers in the service area. The transportation capacity of the service area may include but is not limited a balanced transportation capacity, a surplus transportation capacity, or an insufficient transportation capacity.

The balanced transportation capacity may indicate that the number of candidate service providers is close to the number of service orders in the service area. As used herein, the “close to” may indicate that the difference between the number of service orders and the number of candidate service providers in the service area may be smaller than a first threshold. In some embodiments, the first threshold may have a constant value stored in the storage device 160 or be set by a user (e.g., a user of the O2O service system 100). Additionally or alternatively, the first threshold may be determined by one or more components of the O2O service system 100, such as the transportation capacity status obtaining sub-module 410. For example, the first threshold may be, such as 10% of the number of the service orders or 10% of the number of candidate service providers.

The surplus transportation capacity may indicate that the number of candidate service providers is much greater than the number of service orders in the service area. The insufficient transportation capacity may indicate that the number of candidate service providers is much smaller than the number of service orders in the service area. As used herein, the “much greater than” may indicate that the number of service orders is higher than the number of candidate service providers, and the difference between the number of service orders and the number of candidate service providers is greater than a second threshold. The “much smaller than” may indicate that the number of service orders is smaller than the number of candidate service providers, and the difference between the number of service orders and the number of candidate service providers is greater than a third threshold. The second threshold and/or the third threshold may be similar with the first threshold, and the description thereof is therefore not repeated here. In some embodiments, the second threshold may be equal to or greater than the first threshold. The third threshold may be equal to or greater than the first threshold.

In some embodiments, the transportation capacity status obtaining sub-module 410 may obtain information of transportation capacity of a service area. The information of the transportation capacity of the service area may include but is not limited to a number service orders in the service area, the number of candidate service providers in the service area, the number of service providers in the process of providing service in the service area. Additionally or alternatively, the transportation capacity status obtaining sub-module 410 may determine the transportation capacity of the service area based on the information of the transportation capacity of the service area. The transportation capacity status obtaining sub-module 410 may obtain the information of the transportation capacity and/or determine the transportation capacity in real time or substantially real time. Alternatively, the transportation capacity status obtaining sub-module 410 may obtain the information of the transportation capacity and/or determine the transportation capacity periodically, such as in every five minutes.

If the transportation capacity status obtaining sub-module 410 determines that a service area has an insufficient transportation capacity, the transportation capacity status obtaining sub-module 410 may designate it as a target service area. Additionally or alternatively, the transportation capacity status obtaining sub-module 410 may transmit a dispatch demand associated with the service area with the insufficient transportation capacity to the dispatch module 409.

In some embodiments, the dispatch demand may be associated with a target service area that satisfies a dispatch condition. The dispatch condition may include an occurrence or a prediction of, such as a weather, a time interval of a day, a region, a date, or an event. In some embodiments, the dispatch condition may be predetermined or preset. For example, a service area may be determined as the target service area when its current weather is a preset weather. As another example, a service area may be determined as the target service area when a meeting will be held in the service area tomorrow. The satisfaction of the dispatch condition may indicate that the service area may need service provider(s) dispatched from one or more other service areas.

The weather may include rain, snow, wind, smog or hail, or the like, or any combination thereof. The time interval may include rush hours, such as 7:00 to 9:00 a.m. or 5:00 to 7:00 p.m. The region may include a region that has a probability of having insufficient transportation capacity. The probability of having insufficient transportation capacity may be determined based on, such as a population density, a density of office buildings, the number of historical service orders, or a historical traffic condition. The date may include a weekend, a festival, such as the National Day, the Labor Day, the Valentine's Day. The event may include a meeting, sports event, competition, concert, exhibition, market promotion, or the like, or any combination thereof.

In some embodiments, the determination as to whether a service area satisfies a dispatch condition may be made by one or more components of the O2O service system 100. For example, the detection module 404 may obtain information related to the service area from a storage device in the O2O service system 100 and/or from another system. The detection module 404 may also determine whether the service area satisfies the dispatch condition based on the information. Upon a determination that the service area satisfies the dispatch condition, the detection module 404 may designate the service area as a target service area. Additionally or alternatively, the detection module 404 may transmit a dispatch demand related to the service area to the dispatch module 409.

The information related to the service area may include weather information, traffic information, policy information, news information, or the like, or any combination thereof. Merely by way of example, the detection module 404 may obtain weather information (e.g., real-time weather information, substantially real-time weather information, weather forecast information) from the storage device 160 or a weather forecast resource (e.g., via the Internet). The detection module 404 may determine whether the service area satisfies the dispatch condition (e.g., has a preset weather) currently or at a pre-determined time (e.g., tomorrow). For example, when the service area has the preset weather currently, it may have a real-time dispatch demand. If the service area has the preset weather at the pre-determined time, it may have a non-real-time dispatch demand.

In 520, the processing engine 112 (e.g., the dispatch module 409) may determine one or more first candidate service providers for the dispatch demand. A candidate service provider may refer to a service provider who is waiting for a service order as described in connection with step S10. As used herein, the candidate service provider may also be referred to as a provider terminal of the candidate service provider.

The dispatch module 409 may select the first candidate service providers for the dispatch demand from the candidate service providers in the O2O service system 100 randomly or according to a selection criterion. The selection criterion may include a performance score of a candidate service provider, a distance between the candidate service provider and the target service area, a waiting time of the candidate service provider, an estimated time for the candidate service provider to arrive to the target service area, or the like, or any combination thereof. The waiting time of the candidate service provider may be a duration of time when the candidate service provider is waiting for a service order.

Merely by way of example, the dispatch module 409 may determine a candidate service provider whose distance to the target service area is within a certain distance range as a first candidate service provider for the dispatch demand. Additionally or alternatively, the dispatch module 409 may determine a candidate service provider whose waiting time is greater than a time threshold as the first candidate service provider for the dispatch demand.

In some embodiments, the service area determination module 401 (e.g., the candidate service area determination sub-module 411) may determine one or more candidate service areas associated with the target service area. The dispatch module 409 may then designate one or more service providers in the candidate service areas as the first candidate service providers for the dispatch demand. The candidate service areas may include a service area near the target service area, a service area having a surplus transportation capacity, a transportation capacity having a plenty number of candidate service providers (e.g., the number of candidate service providers being greater than a threshold), or the like, or any combination thereof.

Merely by way of example, the service area determination module 401 may determine a service area near the target service area as the candidate service area. The dispatch module 409 may designate one or more candidate service providers in the service area near the target service area as the first candidate service providers for the dispatch demand. The service area near the target service area may be a service area whose distance to the target service area is smaller than a distance threshold. A distance between the service area and the target service area may be a linear distance or an actual distance (e.g., a distance of a route between the service area and the target service area). The distance between the service area and the target service area may be a distance between a location in the service area and a location in the target service area. For example, the distance between the service area and the target service area may be a distance between central locations in the service area and the target service area. As another example, the candidate service area may be a service area near the target service area and has a surplus transportation capacity. In some embodiments, the transportation capacity status obtaining sub-module 410 may determine the transportation capacity of one or more service areas near the target service area. The candidate service area determination sub-module 411 may determine the service area(s) with a surplus transportation capacity among the service areas near the target service area as the candidate service area(s). More descriptions regarding the determination of a transportation capacity of a service area may be found elsewhere in the present disclosure (e.g., step S10 and the relevant descriptions).

Alternatively, the transportation capacity status obtaining sub-module 410 may obtain information of transportation capacity of one or more service areas near the target service area. The information of a transportation capacity of a service area may include a number service orders in the service area and the number of candidate service providers in the service area. The candidate service area determination sub-module 411 may determine the candidate service area(s) among the service areas near the target service area based on the information of transportation capacity. The candidate service area may be a service area whose number service orders in the service area is much higher than the number of candidate service providers as described in connection with step S10.

In 530, the processing engine 112 (e.g., dispatch request transmission module 402) may transmit a dispatch request to the one or more first candidate service providers. The dispatch request may refer to a request to inquire the first candidate service providers whether to accept to go to the target service area. The dispatch request transmission module 402 may transmit the dispatch request to the provider terminals (e.g., the service provider terminal 140-1) of the first candidate service providers. The dispatch request may be transmitted to the provider terminals in any form, such as a text dispatch request, a video dispatch request, an audio dispatch request, or a graph dispatch request.

In some embodiments, the dispatch request transmission module 402 may transmit the dispatch request to each of the first candidate service providers at the same time. Alternatively, the dispatch request transmission module 402 may transmit the dispatch request to different first candidate service providers at different time. For example, the dispatch request transmission module 402 may transmit the dispatch request to a certain number of candidate service providers among the first candidate service providers periodically. As another example, the dispatch request transmission module 402 may transmit the dispatch request to a first subgroup of the first candidate service providers at a time point. The dispatch request transmission module 402 may transmit the dispatch request to a second subgroup of first candidate service providers at another time point.

A first candidate service provider receiving the dispatch request may reply the dispatch request indicating his or her response to the dispatch request via a provider terminal associated the service provider and the network 120. For example, the first candidate service provider may reply the dispatch request by performing a predetermined action. The predetermined action may indicate a choice of the first candidate service provider regarding the dispatch request. The choice regarding the dispatch request may include accepting to go to the target service area (immediately or at a future time), refusing to go to the target service area, transmitting the dispatch request at a later time, or the like. For example, the first candidate service provider may reply a text message, such as “Yes,” “No,” or “Ask me later” to reply the dispatch request. The text message “Yes” may indicate that the first candidate service provider accepts to go to the target service area. The text message “No” may indicate that the first candidate service provider refuses to go to the target service area. The text message “Ask me later” may indicate that the first candidate service provider wants to receive the dispatch request after a period of time, such as five minutes later.

As another example, the dispatch request transmission module 402 may transmit the dispatch request to an application for the O2O service installed in the provider terminal of the first candidate service provider. The application of the first candidate service provider may display the dispatch request in a user interface. The user interface may include an interface element for the first candidate service provider to reply the dispatch request. For example, the user interface may display a plurality of icons corresponding to choices regarding the dispatch request. The first candidate service provider may click an icon to reply the dispatch request. As another example, the user interface may include an interface element for the first candidate service provider to input text information. The first candidate service provider may input its reply regarding the dispatch request.

In 540, the processing engine 112 (e.g., the dispatch module 409) may determine a second candidate service provider who accepts the dispatch request among the one or more first candidate service providers. As used herein, “accept the dispatch request” may indicate that the second candidate service provider agrees to go to the target service area (immediately or at a future time). The dispatch module 409 may determine the second candidate service provider based on its choice regarding the dispatch request as described in connection with 530. A candidate service provider may be determined as the second candidate service provider when he or she accepts to go to the target service area via the provider terminal.

In 550, the processing engine 112 (e.g., the service order transmission module 403) may transmit a service order associated with the target service area to the second candidate service provider at a first time point. The service order associated with the target service area may be a service order whose start location and/or end location are/is within the target service area.

The first time point may be anytime after the second candidate service provider accepts the dispatch request. For example, the first time point may be a time point when (or immediately after) the second candidate service provider accepts the dispatch request. As another example, the service provider terminal of the second candidate service provider may transmit the positioning information of the second candidate service provider to one or more components (e.g., the service order transmission module 403, the storage device 160) of the O2O service system 100 in real time or periodically. The service order transmission module 403 may receive and/or retrieve the positioning information of the second candidate service provider from the one or more components. The service order transmission module 403 may also determine the first time point based on the positioning information of the second candidate service provider. For example, the first time point may be a time point when the second candidate service provider arrives in the target service area. As another example, the first time point may be a time point when a distance between the second candidate service provider and the target service area is changed from being greater than a distance threshold to being smaller than the distance threshold, such as 500 meters.

In some embodiments, the first time point may be associated with the demand time of the dispatch demand obtained in step S10. For example, the dispatch demand may be triggered by a concert to be held in the target service area. The demand time may be 9:00 p.m. when the concert ends. The first time point may be on or after the demand time. Merely by way of example, the service order transmission module 403 may transmit a service order whose start location is the place of the concert to the second candidate service provider after the concert ends.

In some embodiments, the first time point may be determined based on a service time period of the second candidate service provider. For example, the service time period determination sub-module 412 may determine the service time period of the second candidate service provider. The service order transmission sub-module 413 may then determine the first time point within the service time period of the second candidate service provider.

The service time period determination sub-module 412 may determine any period of time after second candidate service provider accepts the dispatch request as the service time period of the second candidate service provider. For example, the service time period of the second candidate service provider may be 30 minutes after it accepts the dispatch request. The service order transmission sub-module 413 may transmit the service order associated with the target service area to the second candidate service provider at any time point within 30 minutes after it accepts the dispatch request.

As another example, the service time period determination sub-module 412 may determine the service time period based on a first pre-determined service duration and a time point when the second candidate service provider accepts the dispatch request. For example, assuming that the first pre-determined service duration is ΔT₁ and the time point when the second candidate service provider accepts the dispatch request is T₀, the service time period of the second candidate service provider may be (T₀, T₀+ΔT₁). The service order transmission sub-module 413 may transmit the service order associated with the target service area to the second candidate service provider at any time point within the time period of (T₀, T₀+ΔT₁).

As yet another example, the service time period determination sub-module 412 may determine the service time period based on a second pre-determined service duration and a time point when the second candidate service provider arrives in the target service area. For example, assuming that the second pre-determined service duration is ΔT₂ and the time point when the second candidate service provider arrives in the target service area is T₁, the service time of second candidate service provider may be determined as (T₁, T₁+ΔT₂). The service order transmission sub-module 413 may transmit the service order associated with the target service area to the second candidate service provider at any time point within the time period of (T₁, T₁+ΔT₂).

In some embodiments, the service order transmission module 403 may apply different strategies for transmitting service orders according to different situations. For example, the service order transmission module 403 may only transmit a service order associated with the target service area to the second candidate service provider after it accepts the dispatch request. As another example, before the second candidate service provider arrives in the target service area, the service order transmission module 403 may only transmit a service order whose end location is within the target service area to the second candidate service provider. Additionally or alternatively, after the second candidate service provider arrives in the target service area, the service order transmission module 403 may only transmit a service order whose start location is within the target service area to the second candidate service provider.

It should be noted that the above descriptions of process 500 are provided for the purposes of illustration, and not intended to limit the scope of the present disclosure. For persons having ordinary skills in the art, various modifications and changes in the forms and details of the application of the above method and system may occur without departing from the principles of the present disclosure.

However, those variations and modifications also fall within the scope of the present disclosure. In some embodiments, in 530, the dispatch request transmission module 402 may transmit a dispatch request to one or more of the first candidate service providers requiring the receiver(s) to go to the target service area. In 540, the dispatch module 409 may determine a second candidate service provider among the first candidate service providers. In some embodiments, the dispatch module 409 may select the second candidate service among the first candidate service providers randomly. Alternatively, the dispatch module 409 may select the second candidate service among the first candidate service providers according to a selection criterion. The selection criterion may include the performance score of a candidate service provider, the distance between the candidate service provider and the target service area, the estimated time for the candidate service provider to get to the target service area, or the like, or any combination thereof. For example, the dispatch module 409 may select a candidate service provider who has the highest performance score or who is the closest to the target service area among the first candidate service providers. The dispatch module 409 may then designate the selected candidate service provider as the second candidate service provider.

In some embodiments, in 540, a plurality of second candidate service providers who accept the dispatch request (i.e., indicating an agreement to go to the target service area) may be determined. In 550, a service order associated with the target service area may be transmitted to the second candidate service providers. A second service provider who accepts the service order fastest among the second candidate service providers may acquire the service order. Additionally or alternatively, a service order associated with the target service area may be allocated to one of the second candidate service providers randomly or based on an allocation criterion. The allocation criterion may include but is not limited to as an estimated time for a second candidate service provider to get to the start location of the service order, a distance between the second candidate service provider and the start location of the service order.

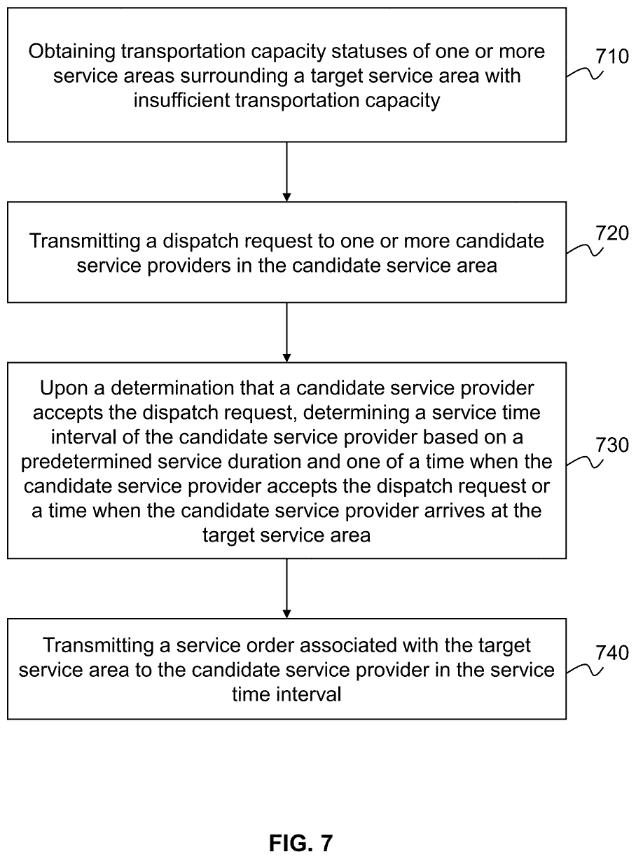

In some embodiments, one or more optional steps may be added. For example, the analysis module 405 may obtain the number of candidate service providers who accept the dispatch request among the first candidate service providers. The analysis module 405 may compare the number with a threshold (e.g., a target number of service providers) to determine whether process 500 need to be terminated. More descriptions regarding the target number of service providers may be found elsewhere in the present disclosure (e.g., FIGS. 7 and 8 and the relevant descriptions). As another example, the reward module 408 may issue a reward to a candidate service provider who accepts the dispatch request and arrives the target service area within a time period. More descriptions regarding the reward of may be found elsewhere in the present disclosure (e.g., FIG. 7 and the relevant descriptions).

FIG. 6 is a flowchart illustrating an exemplary process for dispatching transportation service resource according to some embodiments of the present disclosure. The process 600 may be an embodiment of the process 500 (e.g., steps 520-550) wherein the dispatch demand is associated with a target service area with an insufficient transportation capacity.

The process 600 may be executed by the O2O service system 100. For example, the process 600 may be implemented as a set of instructions (e.g., an application) stored in storage device 160. The processing engine 112 (which may be implemented on the CPU 220) may execute the set of instructions and may accordingly be directed to perform the process 600 in an online O2O service platform. The platform may be an Internet-based platform that connects O2O service providers and requestors through the Internet.

In 610, a candidate service area associated with a target service area having insufficient transportation capacity may be determined. In some embodiments, step 610 may be performed by the processing engine 112 (e.g., the service area determination module 401).

A relatively large area may be divided into a plurality of service areas according to an area-division rule, so as to improve an efficiency for providing an O2O service. For example, an area may be divided into the plurality of service areas according to a distribution of office buildings. As used herein, the service area may refer to an area where a candidate service provider may provide an O2O service.

The candidate service provider may refer to a user who is waiting for a service order, i.e., a service provider for the O2O service. For an online car-hailing service, the candidate service provider may be a driver. For a take-out delivery service, the candidate service provider may be a delivery staff. In another embedment related to another O2O service, the candidate service provider may have another identity. The present disclosure is not limited to the embodiments shown.

A transportation capacity may refer to supply and demand relationship between the number of service orders and the number of candidate service providers in a service area. The service area may have a balanced transportation capacity when the number of candidate service providers is close to the number of service orders in the service area. The service area may have a surplus transportation capacity when the number of candidate service providers is much greater than the number of service orders in the service area. The service area may have an insufficient transportation capacity if the number of candidate service providers is much smaller than the number of service orders in the service area. More descriptions regarding the transportation capacity may be found elsewhere in the present disclosure (e.g., FIG. 5 and the relevant descriptions thereof).

The transportation capacity of the target service area may be determined by determining the number of service orders in the target service area and the number of candidate service providers in the target service area. In some embodiments, the transportation capacity of the target service may be determined by the processing engine 112 (e.g., the transportation capacity status obtaining sub-module 410).

In some embodiments, the transportation capacity of the target service area may be detected in real time. Additionally or alternatively, the transportation capacity of the target service area may be detected only when a dispatch condition is satisfied. To be more specific, the transportation capacity of the target service area may be determined when a preset event occurs. The preset event may include a preset weather, a rush hour, a festival, or a meeting, or the like, or any combination thereof. In some embodiments, the detection module 404 may detect the transportation capacity of the target service area when the dispatch condition is satisfied.

The preset weather may include rain, snow, wind, smog or hail, and/or other bad weather that may affect the traffic. The festival may include a National Day, a Labor Day, and/or another festival when a large amount of people may travel. It can be understood that the preset event may include other types of events such as a star concert. The present disclosure is not limited to the embodiments shown.

The occurrence of the preset event may have an impact on the traffic in one or more service areas. For example, a service area with a plurality of office buildings may have a traffic jam in a rush hour.

In some embodiments, real-time weather information may be obtained from a weather bureau website or the Internet. The real-time weather information may be used to determine whether the current weather is the preset weather. If the current weather is the preset weather, it may be determined that the preset event occurs. Additionally or alternatively, real-time temporal information may be obtained to determine whether it is in, such as the rush hour, and/or the major festival.

In some embodiments, the candidate service area of the target service area may refer to a service area with a surplus transportation capacity. In some embodiments, the candidate service area may be selected from service areas near the target service area. Additionally or alternatively, the candidate service area may be determined based on big data analysis. The candidate service area may be a service area that has surplus transportation capacity in a historical time period. In some embodiments, the candidate service area may be determined by the processing engine 112 (e.g., the candidate service area determination module 410). The historical time period may be any continuous time period and/or any non-continuous time period. For example, the historical time period may be 7:00 to 9:00 a.m. every day in the past week. As another example, the historical time period may be an hour in the past. The present disclosure is not limited to the embodiments shown.

In 620, a dispatch request may be transmitted to one or more candidate service providers in the candidate service area to inquire whether to accept to go to the target service area. A candidate service provider may also be referred as a candidate provider terminal herein. In some embodiments, step 620 may be performed by the processing engine 112 (e.g., the dispatch request transmission module 402).

For an online car-hailing service, the candidate service providers in the candidate service area may be drivers whose present locations are within the candidate service area. For a take-out delivery service, the candidate service providers may be delivery staffs whose delivery regions are within the candidate service area.

In some embodiments, a dispatch request may be transmitted to a candidate service provider via a third party application for O2O service. The third party application may be installed in the provider terminal of the candidate service provider. For an online car-hailing service, the third party application installed in the provider terminal may be a map application or an online car-hailing application for drivers. For a take-out delivery service, the third party application installed in the provider terminal may be a take-out application.

When the dispatch request is transmitted to the third party application related O2O service via the network 120, the third party application may display the dispatch request by a popup window or a card in a user interface of the provider terminal. The popup window or the card may include an interface for the candidate service provider to enter feedback information. It should be noted that the above descriptions of transmitting a dispatch request are provided for the purpose of illustration, and not intended to limit the scope of the present disclosure. The dispatch request may be transmitted to the third party application by any form, such as a video message, an audio message.

The dispatch request may be transmitted to the one or more candidate service providers in the candidate service area, thereby inquiring whether they accept a dispatch in the O2O service system.

In 630, upon a determination that the feedback information of a candidate service provider among the one or more candidate service providers indicates that it accepts to go to the target service area, a service order associated with the target service area may be transmitted to the candidate service provider. The service order associated the target service area may also refer to as the service order in the target service area. In some embodiments, step 630 may be performed by the processing engine 112 (e.g., the service order transmission module 403).

The feedback information may illustrate a choice of the candidate service provider regarding the dispatch request. The choice may include: accepting the dispatch in the O2O service system (i.e., agreeing to go to the target service area to provider service), refusing the dispatch request (i.e., refuse to go to the target service area to provide service).

In some embodiments, if a candidate service provider in the candidate service area accepts the dispatch request, only the service order(s) associated with the target service area may be transmitted to the candidate service provider.

The service order related to an O2O service may include a start location and an end location. For example, for an online car-hailing service, the service order may be a service order for traveling. The service order for traveling may include a pick-up location (i.e., the start location) and a destination (i.e., the end location) of a passenger. As another example, for a take-out delivery service, the service order may be a service order for take-out. The service order for take-out may include a location of a seller (i.e., the start location) and a location of a buyer (i.e., the end location). In some embodiments, the start location and/or the end location of the order transmitted to the service provider may be within the target service area.

Pending service orders, and/or their start locations and end locations in the O2O service system may be obtained. The service orders whose start locations and/or end locations are/is within the target service area may then be selected. At least one of the selected service orders may be transmitted to the candidate service provider who accepts the dispatch request. In some embodiments, the service order that transmitted to the candidate service provider who accepts the dispatch request may be determined by the service order transmission module 403.

For example, for an online car-hailing service, the number of service orders in Xi'erqi Service Area in rush hour may be large while the number of available online hailing cars may be small. The number of available online hailing cars in Shangdi Service Area may be large. The online car-hailing service system may transmit a dispatch request to drivers in the Shangdi Service Area. When a driver accepts the dispatch request, the online car-hailing service system may transmit an order whose start point and/or end point are/is within the Xi'erqi Service Area to the driver.

The above example shows that when the transportation capacity of the target service area is insufficient, it may be possible to dispatch candidate service providers in a service area with a surplus transportation capacity to the target service area and solely transmit service orders in the target service area to the candidate service provider. As such, service resources may be concentrated to a service area with a larger service demand to avoid waste of service resources.

FIG. 7 is a flowchart illustrating an exemplary process for dispatching transportation service resource according to some embodiments of the present disclosure. The process 700 may be an embodiment of the process 600. In the process 700, the candidate service areas may be selected from the service areas near the target service area to improve service efficiency.

The process 700 may be executed by the O2O service system 100. For example, the process 700 may be implemented as a set of instructions (e.g., an application) stored in storage device 160. The processing engine 112 (which may be implemented on the CPU 220) may execute the set of instructions and may accordingly be directed to perform the process 700 in an online O2O service platform. The platform may be an Internet-based platform that connects O2O service providers and requestors through the Internet.

In 710, transportation capacity statues of one or more service areas near a target service area may be obtained if the target service area has an insufficient transportation capacity. In some embodiments, the transportation capacity status obtaining sub-module 410 may obtain the transportation capacity status of the one or more service areas near the target service area. A service area in the one or more service areas near the target service area may be determined to be a candidate service area if it has a surplus transportation capacity. The candidate service area determination sub-module 411 may determine the candidate service area that has the surplus transportation capacity among the one or more service areas near the target service area. Candidate service providers in the service areas near the target service area may arrive in the target service area faster than those in service areas not near the target service area when they accept the dispatch request.

The service area near the target service area may be determined as the candidate service area if it has a surplus transportation capacity. It should be noted that the above descriptions are provided for the purpose of illustration, and not intended to limit the scope of the present disclosure. Any service area near the target service area may be determined as the candidate service area. For example, a service area closest to the target service area may be determined as the candidate service area. As another example, a service area whose number of candidate service providers exceeding a threshold may be determined as the candidate service area. In some embodiments, the candidate service area may be determined by the processing engine 112 (e.g., the candidate service area sub-module 410).

In 720, a dispatch request may be transmitted to one or more candidate service providers in the candidate service area. The dispatch request may be used to inquire whether a candidate service provider agrees to go to the target service area to provide service. Step 720 may be performed in a similar manner with step 620, and the detailed description is not repeated here. In some embodiments, the processing engine 112 (e.g., the dispatch module 409) may determine a candidate service provider who accepts the dispatch request (i.e., indicating an agreement to go to the target service area) among the one or more candidate service providers. The determination of the candidate service provider who accepts the dispatch request may be similar to that described in connection with step S40.

In 730, upon a determination that the candidate service provider of the one or more candidate service providers accepts the dispatch request, a service time period of the candidate service provider may be determined. In some embodiments, step 730 may be performed by the processing engine 112 (e.g., the service time period determination sub-module 412).

The service time period of the candidate service provider may be determined based on a pre-determined service duration and a time point when the candidate service provider accepts the dispatch request, or the pre-determined service duration and a time point when the candidate service provider arrives in the target service area.

An insufficient transportation capacity status of a service area may be relieved or changed to a balanced transportation capacity status after a period of time. The service area may not need transportation capacity dispatched from the candidate service areas after the period of time. As such, a service time period of the candidate service provider accepting the dispatch request may be determined. One or more service orders within the target service area may be transmitted to the candidate service provider during the service time period. A normal order allocation strategy may be applied beyond the service time period. As used herein, the “normal order allocation strategy” may refer to any strategy suitable for the O2O service system 100. For example, the service order transmission module 403 may allocate service orders to candidate service providers based on the distances between start locations of the service orders and the candidate service providers.

In some embodiments, the service time period of a candidate service provider may be determined based on a pre-determined service duration and a time point when the candidate service provider accepts the dispatch request. For example, assuming that the pre-determined service duration is ΔT and the time point when the candidate service provider accepts the dispatch request is T₀, the service time period of the candidate service provider may be (T₀, T₀+ΔT). The service time period of the candidate service provider may be determined by the processing engine 112 (e.g., the service time period determination sub-module 412). Alternatively, the service time period may be determined based on a pre-determined service duration and a time point when the candidate service provider arrives in the target service area. For example, assuming that the pre-determined service duration is ΔT and the time point when the candidate service provider arrives in the target service area is T₁, the service time period of the candidate service provider may be (T₁, T₁+ΔT).

In 740, a service order associated with the target service area may be transmitted to the candidate service provider in the service time period. In some embodiments, step 740 may be performed by the processing engine 112 (e.g., the service order transmission sub-module 413).

In some embodiments, the service time period may be determined based on a pre-determined service duration and a time point when the candidate service provider accepts the dispatch request. During the service time period, only service order whose end location is within the target service area may be transmitted to the candidate service provider before it arrives in the target service area. Only service order whose start location is within the target service area may be transmitted to the candidate service provider after it arrives in the target service area.

Alternatively, the service time period may be determined based on a pre-determined service duration and a time point when the candidate service provider arrives in the target service area. During the service time period, only service order whose start location is within the target service area may be transmitted to the candidate service provider. Before the candidate service provider arrives in the target service area, no service order or only service order whose end location is within the target service area may be transmitted to the candidate service provider.

The above example shows that a candidate service area of a target service area may be selected from service areas near the target service area. Compared with non-near service areas, candidate service providers in the service areas near the target service area may arrive in the target service area faster after they accept the dispatch request. As such, the service efficiency of O2O service may be improved. In addition, it may be possible to transmit a service order associated with the target service area to the candidate service provider in its service time period, and not transmit the service order associated with the target service area to the candidate service provider beyond its service time period. Therefore, it can avoid concentrating service resources in a service area for a long time and avoid a waste of service resources.

In some embodiments, the process 600 and/or the process 700 may include two additional steps S10 and S11 (not shown) as follows. In S10, the number of candidate service providers who agree to go to the target service area to provide service may be determined. In some embodiments, step S10 may be performed by the processing engine 112 (e.g., the analysis module 405). The processing engine 112 (e.g., the analysis module 405) may also determine whether the number of the candidate service providers who agree to go to the target service area is greater than a threshold.

In 511, in response to the number of the candidate service providers who agree to go to the target service area being greater than the threshold, the dispatch request may be stopped from being transmitted to the candidate service providers in the candidate service area. In some embodiments, step S11 may be performed by the control module 406.

In some embodiments, the preset number may be determined based on a target of a balanced transportation capacity of the target service area. The threshold may also be referred herein as a target number of service providers. For example, the threshold may be determined based on a difference between the number of service orders in the target service area and a number candidate service providers in the target service area. The threshold may be equal to the difference. Alternatively, the threshold may be a ratio of the difference, such as 1.1 times of the difference. In some embodiments, the threshold may be a default parameter stored in a storage device (e.g., the storage device 160) or be set by a user (e.g., a user of the O2O service system 100) via a terminal.

In some embodiments, if the candidate service provider who accepts the dispatch request can arrive in the target service area within a predetermined time period, a reward may be issued to the candidate service provider. The pre-determined time period may be any positive number, such as 5 minutes, 10 minutes. The pre-determined time period may be a default parameter stored in a storage device (e.g., the storage device 160) or be set by a user (e.g., a user of the O2O service system 100) via a terminal. The reward may include a monetary reward, a performance score reward, or the like, or any combination thereof. The process 600 and/or the process 700 may include two additional steps: S20 and S21 as described below.

In S20, a judgment may be made as to whether the candidate service provider who accepts the dispatch request arrives in the target service area within the predetermined time period. In some embodiments, S20 may be performed by the processing engine 112 (e.g., the determination module 407).

In S21, upon a determination that the candidate service provider arrives in the target service area within the predetermined time period, the reward may be issued to the candidate service provider. In some embodiments, S21 may be performed by the processing engine 112 (e.g., the reward module 408).

It should be noted that the above descriptions of process 700 are provided for the purposes of illustration, and not intended to limit the scope of the present disclosure. For persons having ordinary skills in the art, various modifications and changes in the forms and details of the application of the above method and system may occur without departing from the principles of the present disclosure. In some embodiments, the order of two or more steps may be changed. Additionally or alternatively, one or more steps may be omitted. In some embodiments, two or more steps may be integrated into a step, or a step may be separated into two steps. For example, a service order may be transmitted to a candidate service provider in a candidate service area without transmitting a dispatch request. As another example, 710 may be separated into two steps. The transportation capacity status obtaining sub-module 410 may obtain transportation capacity statuses of one or more service areas near the target service area with insufficient transportation capacity. The candidate service area determination sub-module 411 may then select a candidate service area of the target service area among the one or more service areas near the target service area.

FIG. 8 is a flowchart illustrating an exemplary process for dispatching transportation service resource according to some embodiments of the present disclosure. The process 800 may be an embodiment of the process 500 wherein the dispatch demand is associated with a target service area that satisfies a dispatch condition.

The process 800 may be executed by the O2O service system 100. For example, the process 800 may be implemented as a set of instructions (e.g., an application) stored in storage device 160. The processing engine 112 (which may be implemented on the CPU 220) may execute the set of instructions and may accordingly be directed to perform the process 800 in an online O2O service platform. The platform may be an Internet-based platform that connects O2O service providers and requestors through the Internet.

In 810, the processing engine 112 (e.g., the dispatch module 409) may obtain a dispatch demand associated with a target service area. The dispatch demand may include a dispatch condition, a demand time, and a target number of service providers. The dispatch demand may be obtained from one or more components of the O2O service system 100, such as the storage device 160, the service area determination module 401, and/or the detection module 404.

The target service area may refer to a service area that needs service provider(s) dispatched from one or more other service areas. The dispatch demand associated with the target service area may refer to a demand for dispatching servicer providers to the target service area. The dispatch condition may include an occurrence or a prediction of, such as a weather, a time interval of the day, a region, a date, or an event. More descriptions regarding the target service area, the dispatch demand, and/or the dispatch condition may be found elsewhere in the present disclosure (e.g., FIG. 5 and the relevant descriptions).

The demand time may refer to a time when the dispatch demand needs to be satisfied as described in connection with FIG. 5. The demand time may be a default time stored in a storage device or a time set by a user of the O2O service system 100. Alternatively, the demand time may be determined by one or more components of the O2O service system 100, such as the dispatch module 409.

Merely by way of example, the dispatch module 409 may determine the demand time based on a time when the dispatch condition is satisfied. The time when the dispatch condition may be a time of the occurrence or the prediction of, such as the weather, the time interval of the day, the date, or the event.

For illustration purposes only, an occurrence or a prediction of the weather (e.g., rain, snow, wind, smog or hail) is described as an example. The dispatch module 409 may obtain weather information associated with the target service area from the storage device 160 or another system (e.g., a weather forecast website). The weather information may include real-time weather information, substantially real-time weather information, weather forecast information, or the like, or any combination thereof. The dispatch module 409 may obtain and/or determine a time or a predicted time when the weather will occur according to the weather information.

For example, if target service area begins raining at a moment, and the dispatch module 409 may determine the moment or a time substantially close to the moment as the demand time. More particular, if the target service area is predicted to rain at 10:00 a.m. tomorrow, the dispatch module 409 may determine 10:00 a.m. tomorrow or a time substantially close to 10:00 a.m. tomorrow as the demand time. It should be noted that the above example is provided for the purpose of illustration, and not intended to limit the scope of the present disclosure. The demand time may be any time point associated with the preset weather.

The target number of service providers may be a target number of service providers to be dispatched to the target service area from one or more other service areas. The target number of service providers may be a default number stored in a storage device or a number set by a user of the O2O service system 100. Alternatively, the target number of service providers may be determined by one or more components of the O2O service system 100, such as the dispatch module 409, the analysis module 405.

For example, the analysis module 405 may determine the target number of service providers based on information of a transportation capacity of the target service area. Merely by way of example, the target number of service providers may be equal to a difference between the number of candidate service providers and the number of service orders in the target service area. As another example, the target number of service providers may be a ratio of the difference, such as 1.1 times of the difference. Additionally or alternatively, the analysis module 405 may determine the target number of service providers based on, such as a density of population, a historical number of service orders, and/or a density of office buildings in the target service area.

In some embodiments, the dispatch demand may be associated with an occurrence or a prediction of an event, such as a meeting, sport event, competition, concert, exhibition, market promotion (e.g., as described in connection with FIG. 5). In some embodiments, the event may be preset. The analysis module 405 may determine the target number of service providers according to or taking into consideration of an estimated number of participants of the preset event. For example, the analysis module 405 may determine the target number of service providers of a dispatch demand associated with a concert according to or taking into consideration of an estimated number of audiences at the concert.

In 820, the processing engine 112 (e.g., the dispatch module 409) may determine one or more first candidate service providers for the dispatch demand at a second time point associated with the demand time. In some embodiments, the second time point may be equal to or substantially close to the demand time. In some embodiments, the second time point may be any time before the demand time. For example, the second time point may be 30 minutes before the demand time. As such, candidate service providers may be determined and dispatched to the target service area before the demand time.

A candidate service provider may refer to a service provider who is waiting for a service order as described in connection with FIG. 5. The dispatch module 409 may determine first candidate service providers for the dispatch demand among the candidate service providers in the O2O service system 100 randomly or according to a criterion. The criterion may include a performance score of the candidate service provider, a distance between the candidate service provider and the target service area, a waiting time of the candidate service provider, an estimated time for the candidate service provider to arrive in the target service area or the like, or any combination thereof.

In some embodiments, the dispatch module 409 may determine a candidate service provider whose distance to the target service area is within a certain distance range as a first candidate service provider for the dispatch demand. Additionally or alternatively, the dispatch module 409 may determine a candidate service provider whose waiting time is greater than a time threshold as the first candidate service provider. In some embodiments, the dispatch module 409 may determine a candidate service provider whose estimated time to arrive in the target service area is close to the demand time as the first candidate service provider (e.g., the difference between the estimated time to arrive in the target service area and the demand time being less than a threshold). For example, a candidate service provider who can arrive in the target service area no later than five minutes after the demand time may be determined as the first candidate service provider. More descriptions regarding the determination of the first candidate service providers may be found elsewhere in the present disclosure (e.g., FIG. 5 and the relevant descriptions).

In 830, the processing engine 112 (e.g., the dispatch request transmission module 402) may transmit a dispatch request to the one or more first candidate service providers to inquire whether to accept to go to the target service area. The first candidate service providers may make a choice regarding the dispatch request. The choice regarding the dispatch request may include accepting to go to the target service area, refusing to go to the target service area, transmitting the dispatch request later, or the like. Step 830 may be performed in a similar manner with 530, and the detailed description is not repeated here.

In some embodiments, the dispatch request transmission module 402 may transmit a dispatch request to at least one of the first candidate service providers requiring the receiver(s) to go to the target service area. In some embodiments, the dispatch request transmission module 402 may determine as to whether to transmit a dispatch request to a first candidate service provider requiring her/him to go to the target service.

For example, the dispatch request transmission module 402 may make the determination based on an estimated reward for dispatch and an estimated cost for the first candidate service provider to arrive in the target service area. The estimated reward for dispatch may include a monetary reward paid to the first candidate service provider for going to the target service area. The estimated reward may be a default value stored in a storage device (e.g., the storage device 160). Additionally or alternatively, the estimated reward may be determined by the reward module 408 based on, for example, the distance between the first candidate service provider and the target service area, the cost of fuel to get to the target service area, etc. The estimated cost for dispatch may refer to the cost for the first candidate service provider to get to the target service area. The estimated cost for the first candidate service provider to arrive in the target service area may be determined based on, for example, a distance between the first candidate service provider and the target service area, or an estimated time to arrive in the target service area. Upon the determination that the estimated reward for dispatch is higher than the estimated cost, the dispatch request transmission module 402 may transmit the dispatch request to the first candidate service provider requiring her/him to go to the target service.

In 840, the processing engine 112 (e.g., the dispatch module 409) may determine a second candidate service provider who accepts the dispatch request among the one or more first candidate service providers. Step 840 may be performed in a similar manner with 530, and the detailed description is not repeated here.

In 850, the processing engine 112 (e.g., the service order transmission module 403) may transmit a service order associated with the target service area to the second candidate service provider at a third time point. The third time point may be any time after the second candidate service provider accepts the dispatch request.

For example, the third time point may be a time point when or immediately after the second candidate service provider accepts the dispatch request. As another example, the third time point may be a time point when the second candidate service provider arrives in the target service area. As yet another example, the third time point may be a time point when a distance between the second candidate service provider and the target service area is changed from being greater than a distance threshold to being smaller than the distance threshold. The distance threshold may be any positive number, such as 500 meters, 1000 meters.

In some embodiments, before the second candidate service provider arrives in the target service area, the service order transmission module 403 may only transmit a service order whose end location is within the target service area to the second candidate service provider. Additionally or alternatively, after the second candidate service provider arrives in the target service area, the service order transmission module 403 may only transmit a service order whose start location is within the target service area to the second candidate service provider. Step 850 may be performed in a similar way as 550, and the detailed description is not repeated here.

In 860, the processing engine 112 (e.g., the analysis module 405) may obtain the number of candidate service providers who accept the dispatch request among the first candidate service providers. The analysis module 405 may obtain the number of candidate service providers who accept the dispatch request from a storage device in the O2O service system 100. Additionally or alternatively, the analysis module 405 may determine the number based on the choices of first candidate service providers regarding the dispatch request as described in connection with step 830.

In 870, the processing engine 112 (e.g., the analysis module 405 may determine whether the number of candidate service providers who accept the dispatch request is less than the target number of service providers. Upon the determination that the number of the candidate service providers who accept the dispatch request is not less than the target number of service providers, the process 800 may be terminated.

Upon the determination that the number of the candidate service providers who accept the dispatch request is less than the target number of service providers, the process 800 may return to step 820 to re-determine one or more first candidate service providers and perform steps 830-870 until the number of candidate service providers who accept the dispatch request is equal to or greater than the target number of service providers. For example, the dispatch module 409 may re-determine a second candidate service provider who accepts the dispatch request. The analysis module 405 may update the number of candidate service providers who accept the dispatch request.

In some embodiments, the dispatch module 409 may re-determine the number of first candidate service providers for the dispatch demand based on the number of first candidate service providers who have accepted the dispatch request and the target number of service providers. For example, the number of the re-determined first candidate service providers may be a difference between the target number of service providers and the number of the first candidate service providers who have accepted the dispatch request.

Further, if the analysis module 405 determines that the updated number of candidate service providers who accept the dispatch request is not less than the target number of service providers, the process 800 may be terminated. On the other hand, if the analysis module determines that the updated number of candidate service providers who accept the dispatch request is less than the target number of service providers, the process 800 may be executed to return to 820 to further re-determine one or more first candidate service providers.

The iteration of steps 820 to 870 may continue until the analysis module 405 determines that newly updated number of candidate service providers who accept the dispatch request is not less than the target number of service providers. In some embodiments, before the process 800 is terminated, the iteration from steps 820 to 870 may be performed periodically, such as in every 2 minutes.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the order of two or more steps may be changed. For example, steps 860 and 870 may be performed before step 830. In some embodiments, one or more steps may be added or omitted. For example, steps 860 and 870 may be omitted.

In some embodiments, the second candidate service provider who accepts the dispatch request may terminate the dispatch via its provider terminal. Additionally or alternatively, the dispatch of the second candidate service provider may be terminated by one or more components of the O2O service system 100. For example, the analysis module 405 may terminate a dispatch of a second candidate service provider before it arrives in the target service area if the analysis module 405 determines that the number of candidate service providers who arrive in the target service area is greater than the target number of service providers. As another example, the service time period determination sub-module 412 may terminate the dispatch when a service time period of the second candidate service provider is over.

It should be noted that the above description of the CNN model is provided for the purpose of illustration, and not intended to limit the scope of the present disclosure. For persons having ordinary skills in the art, modules may be combined in various ways, or connected with other modules as sub-systems. Various variations and modifications may be conducted under the teaching of the present disclosure. However, those variations and modifications may not depart from the spirit and scope of this disclosure. For example, the plurality of parameters (e.g., the number of the kernels, sizes of the kernels, the number of the layers) associated with the CNN model may be adjustable under different situations.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer-readable medium having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out steps for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one non-transitory computer-readable storage medium storing a set of instructions;
at least one processor in communication with the at least one non-transitory computer-readable storage medium, wherein when executing the instructions, the at least one processor is configured to cause the system to:
obtain a dispatch demand associated with a target service area;
determine at least one first candidate service provider for the dispatch demand;
transmit a dispatch request to the at least one first candidate service provider;
determine, among the at least one first candidate service provider, a second candidate service provider; and
transmit a service order associated with the target service area to the second candidate service provider at a first time point.

2. The system of claim 1, wherein:
the dispatch request includes an inquiry to ask the at least one first candidate service provider whether to accept to go to the target service area, and
to determine the second candidate service provider, the at least one processor is configured to cause the system to:
determine, among the at least one first candidate service provider, the second candidate service provider who accepts the dispatch request.

3. The system of claim 1, wherein the first time point is a time point when the second candidate service provider arrives in the target service area.

4. The system of claim 1, wherein to obtain the dispatch demand associated with the target service area, the at least one processor is further configured to cause the system to:
obtain first information of a transportation capacity of at least one service area;
determine, among the at least one service area, the target service area based on the first information of the transportation capacity of the at least one service area.

5. The system of claim 1, wherein to determine the at least one first candidate service provider for the dispatch demand, the at least one processor is further configured to cause the system to:
determine at least one candidate service area associated with the target service area; and
determine the at least one first candidate service provider in the at least one candidate service area.

6. The system of claim 5, wherein to determine the at least one candidate service area associated with the target service area, the at least one processor is further configured to cause the system to:
obtain second information of a transportation capacity of at least one service area near the target service area; and
determine the at least one candidate service area among the at least one service area near the target service area based on the second information of the transportation capacity of the at least one service area near the target service area.

7. The system of claim 1, wherein to transmit the service order associated with the target service area to the second candidate service provider at the first time point, the at least one processor is further configured to cause the system to:
determine a first service time period of the second candidate service provider based on a first pre-determined service duration and the time point when the second candidate service provider accepts the dispatch request;
determine the first time point within the first service time period of the second candidate service provider; and
transmit the service order associated with the target service area to the second candidate service provider at the determined first time point.

8. The system of claim 1, wherein to transmit the service order associated with the target service area to the second candidate service provider at the first time point, the at least one processor is further configured to cause the system to:
determine a second service time period of the second candidate service provider based on a second pre-determined service duration and the time point when the second candidate service provider arrives in the target service area;
determine the first time point within the second service time period of the second candidate service provider; and
transmit the service order associated with the target service area to the second candidate service provider at the determined first time point.

9. The system of claim 1, wherein the at least one processor is further configured to cause the system to:
obtain the number of candidate service providers who accept the dispatch request among the at least one first candidate service provide;
determine whether the obtained number of the candidate service providers who accept the dispatch request exceeds a threshold; and
upon a determination that the obtained number of the candidate service providers who accept the dispatch request exceeds the threshold, stop transmitting the dispatch request to the at least one first candidate service provider.

10. The system of claim 1, wherein:
the dispatch demand further includes a demand time related to a dispatch condition, and
to determine the at least one first candidate service provider for the dispatch demand, the at least one processor is further configured to cause the system to determine the at least one first candidate service provider at a second time point associated with the demand time related to the dispatch condition.

11. The system of claim 10, wherein the dispatch condition is at least one of a weather, a time interval of a day, a region, a date, or an event.

12. The system of claim 10, wherein:
the dispatch demand further includes a target number of service providers, and
the at least one processor is further configured to cause the system to:
obtain the number of candidate service providers who accept the dispatch request among the at least one first candidate service provider;
determine whether the obtained number is less than the target number of service providers;
upon a determination that the obtained number is less than the target number of service providers, obtain at least one third candidate service provider for the dispatch demand.

13. A method implemented on a computing device having at least one processor and at least one storage device, comprising:
obtaining a dispatch demand associated with a target service area;
determining at least one first candidate service provider for the dispatch demand;
transmitting a dispatch request to the at least one first candidate service provider;
determining, among the at least one first candidate service provider, a second candidate service provider; and
transmitting a service order associated with the target service area to the second candidate service provider at a first time point.

14. The method of claim 13, wherein:
the dispatch request includes an inquiry to ask the at least one first candidate service provider whether to accept to go to the target service area, and the determining the second candidate service provider further comprises:
determining, among the at least one first candidate service provider, the second candidate service provider who accepts the dispatch request.

15. (canceled)

16. The method of claim 13, wherein the obtaining the dispatch demand associated with the target service area further comprises:
obtaining first information of a transportation capacity of at least one service area; and
determining, among the at least one service area, the target service area based on the first information of the transportation capacity of the at least one service area.

17. The method of claim 13, wherein the determining the at least one first candidate service provider for the dispatch demand further comprises:
obtaining second information of a transportation capacity of at least one service area near the target service area;
determining, based on the second information, at least one candidate service area associated with the target service area; and
determining the at least one first candidate service provider in the at least one candidate service area.

18. (canceled)

19. The method of claim 13, wherein the transmitting the service order associated with the target service area to the second candidate service provider at the first time point further comprises:
determining a first service time period of the second candidate service provider based on a first pre-determined service duration and the time point when the second candidate service provider accepts the dispatch request;
determining the first time point within the first service time period of the second candidate service provider; and
transmitting the service order associated with the target service area to the second candidate service provider at the determined first time point.

20. The method of claim 13, wherein the transmitting the service order associated with the target service area to the second candidate service provider at the first time point further comprises:
determining a second service time period of the second candidate service provider based on a second pre-determined service duration and the time point when the second candidate service provider arrives in the target service area;
determining the first time point within the second service time period of the second candidate service provider; and
transmitting the service order associated with the target service area to the second candidate service provider at the determined first time point.

21. (canceled)

22. The method of claim 13, wherein:
the dispatch demand further includes a demand time related to a dispatch condition, and
the determining the at least one first candidate service provider for the dispatch demand further comprises:
determining the at least one first candidate service provider at a second time point associated with the demand time related to the dispatch condition.

23-25. (canceled)

26. A non-transitory computer-readable medium storing instructions that, when executed by at least one processor of a system, cause the system to perform a method, the method comprising:
determining at least one first candidate service provider for the dispatch demand;
transmitting a dispatch request to the at least one first candidate service provider;
determining, among the at least one first candidate service provider, a second candidate service provider ; and
transmitting a service order associated with the target service area to the second candidate service provider at a first time point.
